(19) United States
(12) Patent Application Publication
(10) Pub. No.: US 2024/0276946 A1
(43) Pub. Date: Aug. 22, 2024

(54) SYSTEM AND METHOD FOR REMOVING MANURE FROM A FLOOR IN A BARN, AND, IN COMBINATION, A BARN FOR KEEPING ANIMALS AND A SYSTEM OF THIS TYPE

(71) Applicant: LELY PATENT N.V., Maassluis (NL)

(72) Inventors: Harm JORNA, Gouda (NL); Robin Andreas Albertus VAN KESTER, 's-Gravenzande (NL)

(73) Assignee: LELY PATENT N.V., Maassluis (NL)

(21) Appl. No.: 18/573,291

(22) PCT Filed: Jul. 7, 2022
(86) PCT No.: PCT/IB2022/056293

§ 371 Date: Dec. 21, 2023

(30) Foreign Application Priority Data
Jul. 27, 2021 (NL) 2028856

(51) Int. Cl. A01K 1/01

(52) U.S. Cl. CPC A01K 1/0128

(57) ABSTRACT

A system for removing manure from a floor in a barn, such as cows, includes an autonomous manure removing vehicle provided with a drive system for driving the manure removing vehicle. The drive system includes at least one electrical drive motor. An electronic control system is connected to the drive system for controlling the latter. A battery system for storing electrical energy is connected to the drive system and the control system. The manure removing vehicle includes a manure bounding device with a manure slider for moving manure over the floor while the manure removing vehicle travels across the floor. The manure bounding device is configured to at least partially bound the manure present on the floor in front of the manure slider. The system includes a charging station for charging the battery system of the manure removing vehicle when the manure removing vehicle is in the charging station in a charging position. The charging station includes a manure blocking device which, together with the manure bounding device, is configured to define, in the charging position of the manure removing vehicle, a holding space substantially closed off for manure.

The invention relates to a system for removing manure from a floor in a barn for keeping animals, such as cow manure, using an electrically driven, autonomous manure removing vehicle. The “removal of manure” not only includes the taking up of manure from a floor, for example by sucking up, picking up, scooping up and the like, but also moving manure over a floor containing slotted holes, i.e. a “grid floor” or “slatted floor”, in order to discharge this manure to a manure reservoir under the floor. With a grid floor, it is possible to remove the manure on the floor by pushing the manure through the slotted holes, so that the manure drops into the manure reservoir under the floor.

The Lely Discovery 120 Collector® is known. This is an autonomous manure removing vehicle for removing manure from a solid floor of a barn. The vehicle can find its way autonomously by means of an electronic control system with sensors, such as an ultrasound sensor and a gyroscope. On the basis of the signals detected by the sensors, the control system controls a drive system with electrical drive motors for the wheels of the vehicle. Consequently the vehicle can be steered and can travel along a desired route. The drive system and the control system are powered by a battery system on board the vehicle. The battery system is connected to electrically conductive charging strips which extend on the outside of the vehicle. In order to charge the battery system, the vehicle travels to a charging station with charging electrodes. In the charging station, the vehicle maneuvers to a charging position, in which the charging strips on the outside of the vehicle make contact with the charging electrodes of the charging station and charging current can be supplied to the battery system.

The manure removing vehicle comprises a manure slider or manure scraper for moving and/or scraping manure over the floor. The manure slider runs substantially at right angles to the direction of travel. While the manure removing vehicle is travelling, the manure slider slides across the floor of the barn. The manure slider is in contact with the floor in order to move and/or scrape the manure which is present thereon. An amount of manure on the solid floor accumulates in front of the manure slider, i.e. a “manure bath” is produced in front of the manure slider. In addition, the Lely Discovery 120 Collector® has sliding supports or sliding blocks on either side of the manure slider which support the manure removing vehicle when travelling across the floor of the barn. The sliding supports are in contact with the floor in such a way that the manure bath on the floor in front of the manure slider is also bounded by the sliding supports. Therefore, the manure slider and sliding supports form part of a manure bounding device which bounds the manure bath on the floor in front of the manure slider during travel. The manure bounding device is in movable contact with the floor. The manure slider bounds the manure bath on the rear side and/or laterally, and the sliding supports bound the manure bath laterally on either side of the manure slider.

When the battery system is being charged, i.e. while the manure removing vehicle is stationary in the charging position on the solid floor in the charging station, the manure of the manure bath in front of the manure slider may, however, partly run off across the floor. This manure can harden after some time (“cake”). In and around the charging station, the floor becomes (very) soiled, as a result of which harmful bacteria may develop. Also, the soiling caused by manure running off may lead to problems with regard to aligning the vehicle in the charging station into the charging position when the vehicle later returns in order to charge the battery system again.

It is an object of the invention to provide an improved system for removing manure from a floor in a barn with animals, wherein in particular the charging of the autonomous manure removing vehicle is more reliable.

According to the invention, this object is achieved by a system for removing manure and/or urine from a floor in a barn for keeping animals, such as dairy cows, cows for meat production, pigs or goats, which system is provided with:
an autonomous manure removing vehicle for removing manure and/or urine from the floor in the barn, wherein the vehicle comprises:
   a drive system for driving the manure removing vehicle, which drive system is provided with at least one electrical drive motor,
   an electronic control system which is connected to the drive system for control thereof,
   a battery system for storing electrical energy, which battery system is connected to the drive system and the control system,
   a manure bounding device which comprises a manure slider, wherein the manure slider is configured to move manure over the floor while the manure removing vehicle travels across the floor, and wherein the manure bounding device is configured to at least partially bound the manure present on the floor in front of the manure slider,
a charging station for charging the battery system of the manure removing vehicle when the manure removing vehicle is in the charging station in a charging position,
   wherein the charging station comprises a manure blocking device which, together with the manure bounding device, is configured to define or form, in the charging position of the manure removing vehicle, a holding space which is substantially closed off for manure.

The manure slider or manure scraper is configured to move and/or scrape manure over the floor while the manure removing vehicle travels across the floor. The manure slider extends, for example, substantially at right angles to the direction of travel. While the manure removing vehicle is travelling, the manure slider slides across the floor of the barn. The manure slider is in contact with the floor in order to move and/or scrape the manure present thereon. The manure situated in front of the manure slider is at least partially bounded by the manure bounding device which in any case comprises the manure slider. The manure slider bounds the manure which lies in front of the manure slider on the floor on the rear side, and possibly also laterally, depending on the shape of the manure slider. In addition, the manure bounding device may comprise further manure bounding elements. For example, the manure bounding device, similar to the above-described Lely Discovery 120 Collector®, may comprise sliding supports which are arranged on either side of the manure slider and support the manure removing vehicle when it travels across the floor of the barn. The sliding supports are in contact with the floor in such a way that the manure on the floor in front of the manure slider is also bounded laterally by the sliding supports.

The manure removing vehicle travels to the charging station in order to charge the battery system. The manure removing vehicle enters the charging station and maneuvers itself into the charging position, so that electrical energy is transferable to charge the battery system. According to the invention, when the manure removing vehicle has reached the charging position, the manure blocking device of the charging station lies close to or even against the manure bounding device of the manure removing vehicle, in particular a front side thereof, in such a way that the manure blocking device and the manure bounding device together delimit a holding space which is substantially closed off for manure. Although a (very) small amount of manure may possibly seep away via slits, in particular thin manure, the holding space delimits a floor area in the charging station which is substantially closed off for manure, i.e. manure in front of the manure slider is contained in a section of the floor in the charging station. While the manure removing vehicle is stationary on the floor in the charging station in the charging position in order to charge the battery system, the manure blocking device of the charging station according to the invention prevents the manure present in front of the manure slider from freely running off across the floor. The manure in front of the manure slider, and possibly other components of the manure bounding device, is enclosed by means of the manure blocking device, i.e. this manure remains inside the holding space which is substantially closed off for manure. As a result thereof, the floor in and around the charging station remains clean for longer, so that the charging of the battery system is less quickly adversely affected by soiling caused by manure flowing off. Charging the battery system of the manure removing vehicle also works reliably when the system according to the invention has been in use for some time.

The advantages of the invention become evident in particular with a solid floor. In a preferred embodiment, the manure slider is configured to collect an amount of manure in front of the manure slider while the manure removing vehicle travels across the floor which is, in particular, a solid floor, wherein the manure removing vehicle is provided with a manure storage container, and a manure feed device for feeding or introducing manure which is collected in front of the manure slider while the manure removing vehicle is travelling and for moving this fed-in or introduced manure to the manure storage container. With a solid floor, an amount of manure accumulates in front of the manure slider, i.e. a “manure bath” is produced in front of the manure slider. In this case, the manure slider comprises, for example, an accumulating/sliding beam. The accumulated manure in front of the manure slider may be sucked up or picked up, e.g. by being raised via a rotating input, and be temporarily stored in the manure storage container. In other words, while travelling across the floor, the manure removing vehicle collects manure from the floor in the manure storage container. However, when the manure removing vehicle is stationary in the charging station in order to be charged, the solid floor does not allow any manure to pass through. As a result thereof, the accumulated manure in front of the manure slider and, in the case of a manure removing vehicle which sucks up manure, also manure which flows out of the manure storage container when the vacuum pump is switched off during charging, in particular thin manure, will tend to run off across the solid floor and into the charging station on account of the force of gravity. In order to prevent the floor in and around the charging station from becoming very soiled, the manure blocking device according to the invention substantially closes off the manure bath. The accumulated manure remains enclosed in the charging station and is not able to flow away, or hardly.

In an embodiment according to the invention, the manure feed device comprises a manure feed opening which is connected to the manure storage container. The manure collected in front of the manure slider is moved to the manure storage container via the manure feed opening. The manure removing vehicle may furthermore comprise a manure discharge opening for discharging manure from the manure storage container which is arranged, in particular, in the bottom of the manure storage container. It is possible both for the manure discharge opening to be combined with the manure feed opening, i.e. the manure feed opening and the manure discharge opening are formed by one and the same opening, and for the manure discharge opening to be a separate, second opening which is closeable, for example, by a controllable discharge valve.

In an embodiment according to the invention, the system comprises at least one dump which is situated at a distance from the charging station. The charging station is arranged at a first location, such as in the barn, and the dump is arranged at a second location at a travelling distance from the first location, for example somewhere else in the barn or outside the barn. The charging station and the dump are arranged separate from one another. In this case, the charging station does not have any facilities to remove the manure from the manure storage container, in particular the charging station does not have a dumping opening for dumping the manure. The manure is discharged elsewhere, namely at the dump. With a charging station which is not configured to simultaneously function as a dump, the manure from the manure storage container cannot be discharged during the charging operation. When the manure removing vehicle is stationary in the charging station in order to be charged, the manure blocking device according to the invention prevents the accumulated manure in front of the manure slider from running off across the floor in and around the charging station. The manure bath of accumulated manure in front of the manure slider remains substantially contained in the holding space in the charging station and cannot flow away, or hardly.

The dump may be configured in different ways. If the dump is situated in the barn, the dump comprises, for example, a dumping opening in the floor for dumping manure from the manure discharge opening of the manure storage container through the dumping opening into a manure reservoir or manure pit which extends under the floor. When the manure discharge opening of the manure removing vehicle is situated over the dumping opening, the manure from the manure storage container is discharged to the manure reservoir via the dumping opening. However, the dump may also be situated outside the barn, in particular in the case of an open-air manure reservoir, such as a so-called “manure lagoon”. In this case, the dump may be configured for dumping manure from the manure discharge opening of the manure storage container into the open-air manure reservoir.

When the manure storage container is full, the manure feed device stops introducing manure and the manure removing vehicle travels to the dump in order to empty the manure storage container. Also, if it is desired to charge the manure removing vehicle, the manure removing vehicle preferably does not travel directly to the charging station, but first to the dump in order to discharge the manure from the manure storage container. When the manure storage container has been substantially emptied at the dump, the manure removing vehicle then travels from the dump to the charging station in order to charge the battery system. As a result thereof, an amount of manure is again collected in front of the manure slider. During charging, the manure bath in front of the manure slider is closed off by the manure blocking device, so that the manure cannot flow away, or hardly, and the floor in and around the charging station remains substantially clean. After the charging operation, the manure removing vehicle leaves the charging station in order to continue with its manure-removal duties.

In an embodiment according to the invention, the charging station comprises a substantially solid floor. As described above for use with a manure removing vehicle for solid floors, i.e. wherein manure is removed from the floor and fed or introduced into a manure storage container and the fed-in or introduced manure is subsequently discharged at a dump, the charging station would normally have a solid floor without a dumping opening, since the charging station and the dump are separate from one another. In such an embodiment of the charging station, the manure blocking device prevents manure from the manure bath in front of the manure slider from causing soiling in and around the charging station.

According to the invention, it is also possible that the manure removing vehicle is configured for use with a grid floor or slatted floor, i.e. a floor comprising slots and a manure reservoir or manure pit under the floor of the barn for holding manure which has been moved through the slots by the scraping action of the manure removing vehicle. In other words, while the manure removing vehicle is travelling, the manure slider slides across the floor of the barn in order to force the manure through the slots which then drops into the manure reservoir on account of the force of gravity. In this way, the manure is removed from the grid floor.

With a system comprising a manure removing vehicle which moves manure through a grid floor, the floor of the charging station may also be solid locally. In this case, there is substantially the same problem of an amount of manure in front of the manure slider which may run off across this solid floor of the charging station while the manure removing vehicle is stationary in the charging position. In order to also prevent soiling in and around the charging station in this case, the manure which is situated in front of the manure slider may be substantially blocked by means of the manure blocking device according to the invention. Incidentally, the manure blocking device according to the invention may even offer advantages if the grid floor continues into the charging station, i.e. if the floor in the charging station is provided with slots, in particular in the case of thick manure which does not drop through the slots of the grid floor into the charging station easily when the manure removing vehicle is stationary in order to be charged.

In an embodiment, the manure slider has a slider width, wherein the manure blocking device comprises a manure blocking beam having a width which substantially corresponds to the slider width of the manure slider. The manure blocking beam is, for example, made of wood or metal, such as stainless steel. If the width of the manure blocking beam is substantially equal to the slider width of the manure slider, i.e. the width of the manure slider viewed in the direction at right angles to the direction of travel of the manure removing vehicle, the manure blocking beam can reliably block the manure situated in front of the manure slider in the charging position.

In an embodiment according to the invention, the charging station, in the charging position of the manure removing vehicle, is situated adjacent to a front side of the manure removing vehicle, wherein the control system is configured to control the drive system of the manure removing vehicle in such a way that the manure removing vehicle rotates to leave the charging station after the battery system has been charged, optionally after the manure removing vehicle has first reversed over a distance. In order to charge the battery system, the manure removing vehicle travels in a forward direction of travel into the charging station, for example until a front side of the manure removing vehicle comes to lie against the manure blocking device of the charging station. Then, the manure removing vehicle has reached the charging position. After charging, the manure removing vehicle cannot leave the charging station by travelling in a forward, straight direction, because the charging station is in the way. Therefore, the manure removing vehicle performs a rotation in order to leave the charging station. If the manure removing vehicle is mechanically coupled to the charging station for charging, the manure removing vehicle may first reverse slightly in order to first uncouple the manure removing vehicle before the manure removing vehicle rotates to leave the charging station.

In this embodiment and arrangement of the charging station, the advantages of the invention are particularly evident. If the manure removing vehicle could leave the charging station in a forward, straight direction, the vehicle would again remove a large part of any escaped manure and introduce it into the manure storage container. However, with a charging station which is arranged in front of the manure removing vehicle, so that the vehicle has to rotate sideways before it can remove the charging station, the vehicle would largely leave the escaped manure behind. By using the manure blocking device according to the invention, manure is virtually entirely prevented from escaping, so that the floor in and around the charging station remains clean, also in case the charging station is arranged on the front side of the vehicle in the charging position.

In a preferred embodiment according to the invention, the manure bounding device of the manure removing vehicle comprises at least one front end which, in the charging position of the manure removing vehicle, lies near the manure blocking device, in particular at a distance of less than 10 cm, preferably less than 5 cm, or lies against the manure blocking device, wherein the control system is configured to control the drive system of the manure removing vehicle in such a way that, during the rotation to leave the charging station, the front end moves along, in particular substantially parallel to, and/or in contact with at least a portion of the manure blocking device, in particular the front end which makes the widest bend when rotating to leave the charging station. The manure bounding device may comprise one or more front ends on each side of the manure removing vehicle, i.e. on the left and on the right, depending on the embodiment and the design of the manure bounding device. While the manure removing vehicle is being charged, the manure is substantially enclosed in the holding space, which is formed by the manure bounding device and the manure blocking device together. The enclosed manure will spread across the floor area of the holding space during the charging operation. When the manure removing vehicle leaves the charging station, this enclosed manure is released. Optionally, the manure removing vehicle first reverses over a small distance after the charging operation in order to interrupt the charging operation, wherein this distance also depends on the position of the manure blocking device. The manure removing vehicle makes a sharp bend to leave the charging station, wherein at least one of the front ends of the manure bounding device moves substantially close along the manure blocking device or even makes contact with the manure blocking device, i.e. slides along the manure blocking device, so that the manure removing vehicle carries along virtually all the released manure from the charging station. The manure which was contained on the floor in the holding space during the charging operation is largely removed by the manure removing vehicle and subsequently introduced into the manure storage container, so that hardly any manure remains behind. As a result thereof, the charging station and the floor in and around the charging station remain clean for a particularly long period of time.

In a preferred embodiment, the charging station comprises an exit side via which the manure removing vehicle leaves the charging station in a lateral direction, wherein the manure blocking device comprises an outer end which is situated on the exit side of the charging station, and wherein one or more of the front ends which lie near or against the manure blocking device in the charging position of the manure removing vehicle are situated at a distance from the exit side in said charging position, i.e. said front end or said front ends are situated on the side of the charging station opposite the exit side, and wherein, during the rotation of the manure removing vehicle to leave the charging station, said front end or said front ends moves or move along, in particular substantially parallel to, and/or in contact with the manure blocking device up to the outer end. If the exit side is situated, for example, to the right of the charging station, one or more left-hand front ends of the manure bounding device of the manure removing vehicle, during the rotation to leave, move or slide along the manure blocking device up to and including the outer end thereof. As a result thereof, as much manure as possible is removed from the charging station during the exiting operation.

In an embodiment, the charging station comprises a transmitting body comprising a primary coil, and the manure removing vehicle comprises a receiving body comprising a secondary coil, wherein the manure removing vehicle is maneuverable with respect to the transmitting body of the charging station in such a way that the primary coil of the transmitting body and the secondary coil of the receiving body are mutually aligned in order to wirelessly transfer electrical energy from the primary coil to the secondary coil for wireless charging of the battery system of the manure removing vehicle.

In particular, the transmitting body comprises a transmitting plate comprising the primary coil. The transmitting plate is, for example, arranged adjacent to a flat surface of the transmitting body. The receiving body may comprise a receiving plate comprising the secondary coil, wherein the receiving plate is, for example, arranged adjacent to a flat surface of the receiving body. In this case, the transmitting plate and the receiving plate may each be formed by a round disk (“charging pad”), in particular having a diameter of 10 to 30 cm and/or a thickness of 1 to 2 cm. The transmitting body and the receiving body comprising such a charging pad may themselves have a different suitable shape, such as a droplet shape, a rectangular shape or otherwise. The primary and secondary coil may each comprise one or more induction coils, for example a packet of induction coils. The term “coil” is to be understood as meaning a device which comprises one or more induction coils.

For efficient wireless energy transfer, it is important to (very) accurately align the primary coil of the transmitting body and the secondary coil of the receiving body with respect to one another, in particular with an accuracy in the order of magnitude of centimeters, for example at a mutual distance of less than 5 cm, preferably less than 3 cm, such as substantially 2 cm or less. Soiling caused by escaped manure during the charging operation may cause alignment problems when the manure removing vehicle subsequently returns in order to recharge the battery system. Wirelessly charging the manure blocking device therefore offers significant advantages.

In addition, with wireless charging, it is preferable to design the charging station and the manure removing vehicle in such a way that the front side of the manure removing vehicle in the charging position lies against the charging station, and in this case the advantages of the manure blocking device according to the invention become particularly evident, as has been described above. But also with a charging station with charging electrodes which make contact with electrically conductive charging strips which extend on the outside of the manure removing vehicle, and wherein the charging station is arranged in front of the manure removing vehicle, it is important to keep the charging station clean in order not to adversely affect the alignment of the charging strips with respect to the charging electrodes.

In an embodiment according to the invention, the manure slider comprises a flexible bottom edge which is configured to move and/or scrape manure across the floor. When the manure removing vehicle is travelling across the floor, the flexible bottom edge of the manure slider is in contact with the floor in order to move and/or scrape any manure present thereon. While the bottom edge is moving across the floor, it is elastically deformed, i.e. the bottom edge is bent slightly during contact with the floor, so that the bottom edge exerts a pressure force on the floor during the scraping action. As a result thereof, manure is efficiently removed from the floor.

In an embodiment according to the invention, the manure bounding device comprises sliding supports which are arranged in front of the manure slider and on either side thereof, wherein the sliding supports are configured to rest on the floor while the manure removing vehicle is travelling across the floor, and wherein the sliding supports each comprise a front end which lies near or against the manure blocking device of the charging station in the charging position of the manure removing vehicle. The sliding supports are substantially in manure blocking contact with the floor and also adjoin the front ends of the manure slider or front ends of other sliding supports in a substantially manure blocking manner. The bottom edge of the manure slider and the bottom edge of sliding supports on either side of the manure slider together form a composite manure bounding edge of the manure bounding device. The manure on the floor in front of the manure slider is bounded on the rear side and laterally by this manure bounding edge, i.e. manure is substantially detained and cannot flow under the bottom edges of the manure slider or sliding supports or in between. In the charging position, the manure blocking device lies close to, i.e. substantially manure blocking, or against the front ends of the sliding supports, so that the holding space which is substantially closed off for manure according to the invention is formed. This holding space is then delimited by a continuous composite manure blocking edge which comprises the bottom edge of the manure slider, the bottom edge of the sliding supports on either side of the manure slider, and the bottom edge of the manure blocking device. Although slits may be present between these bottom edges, as a result of which a small amount of manure may possibly seep away, in particular thin manure, the manure remains substantially contained in the holding space.

In an embodiment, the system comprises a water system for applying water to the floor of the charging station, for example by spraying water. It is advantageous to wet the floor of the charging station in order to support removal of the manure when the manure removing vehicle leaves the charging station after charging.

The water system may be configured in various ways. For example, the manure removing vehicle comprises the water system. In this case, it is possible for the water system to be provided with at least one water reservoir for holding water, at least one spray head for spraying water on the floor, and a water feed connection for supplying water to the water system. The water feed connection, the water reservoir and the spray head of the water system are connected to each other by means of a conduit system. In this case, the system may comprise a water station with a water supply connection which is couplable to the water feed connection of the water system for supplying water to the water system in order to fill the water reservoir.

In addition, it is possible for the charging station to comprise the water system, for example one or more spray heads which are connected to a water supply connection and configured to spray water on the floor of the charging station during and/or after charging.

The invention also relates to, in combination, a barn for keeping animals, such as dairy cows or cows for meat production, and a system such as described above. In particular, the manure removing vehicle and the charging station are situated in the barn, i.e. in the space for keeping the animals. As has already been mentioned above, the dump may however also be situated outside the barn.

The invention furthermore relates to a method for removing manure and/or urine from a floor in a barn for keeping animals, such as dairy cows, cows for meat production, pigs or goats, wherein use is made of a system as described above, and wherein the method comprises:
moving the autonomous manure removing vehicle across the floor of the barn in order to remove manure from the floor,
moving the manure removing vehicle to the charging station, and
maneuvering the manure removing vehicle to the charging position in the charging station, in which the manure blocking device and the manure bounding device together define or form the holding space which is substantially closed off for manure.

By maneuvering the manure removing vehicle to the charging position in the charging station, the manure bounding device of the manure removing vehicle is arranged near or against the manure blocking device of the charging station in such a way that the manure blocking device and the manure bounding device together define or form the holding space which is substantially closed off for manure. If the manure removing vehicle is configured to have a manure storage container for temporarily collecting manure which has been removed from the floor, and the manure removing vehicle travels to the dump in order to empty the manure storage container when it is full, the battery system is in particular charged after the manure has been dumped.

The method according to the invention has the same technical effects and advantages as described above with regard to the system according to the invention.

The invention will now be explained in more detail with reference to the attached figures.

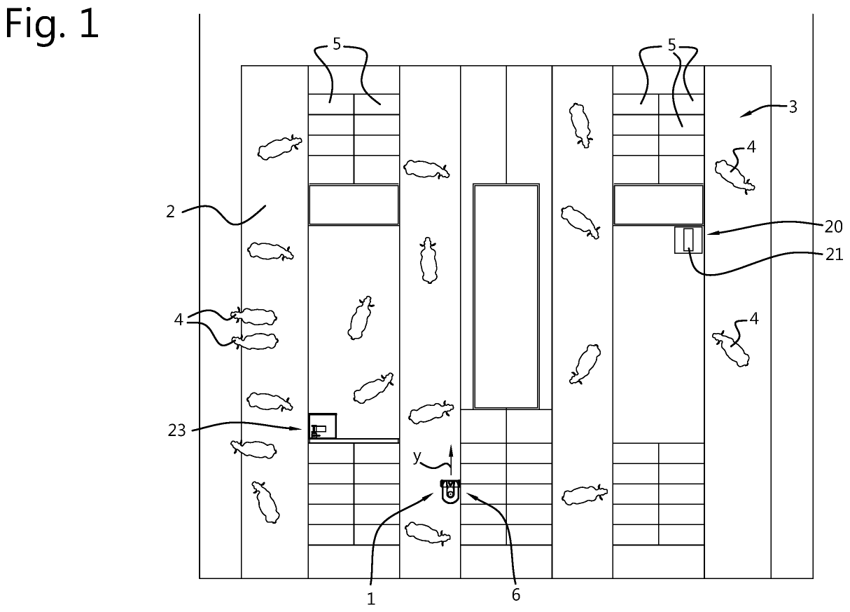

FIG. 1 shows a diagrammatic top view of a barn with a system according to the invention, wherein the system is provided with an autonomous manure removing vehicle, a charging station and a dump.

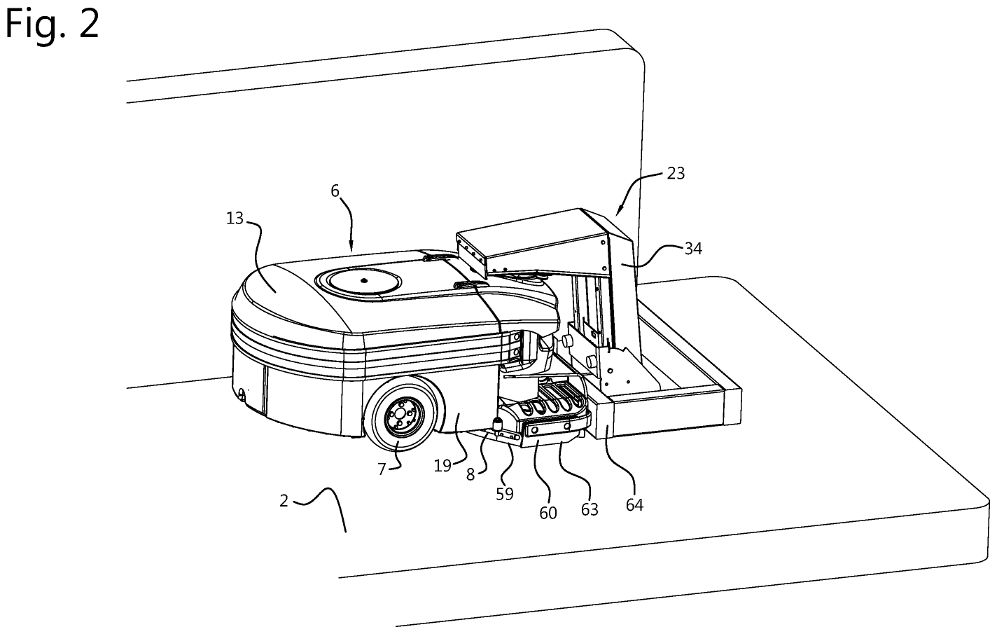

FIG. 2 shows a view in perspective of the manure removing vehicle in the charging station of the system shown in FIG. 1.

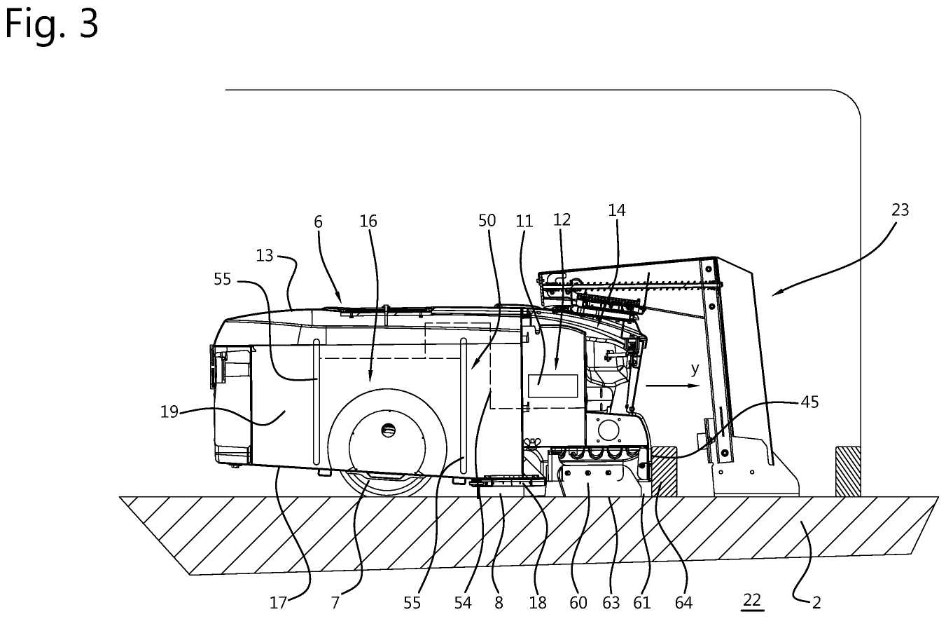

FIG. 3 shows a partially cut-away side view of the manure removing vehicle in the charging station illustrated in FIG. 2.

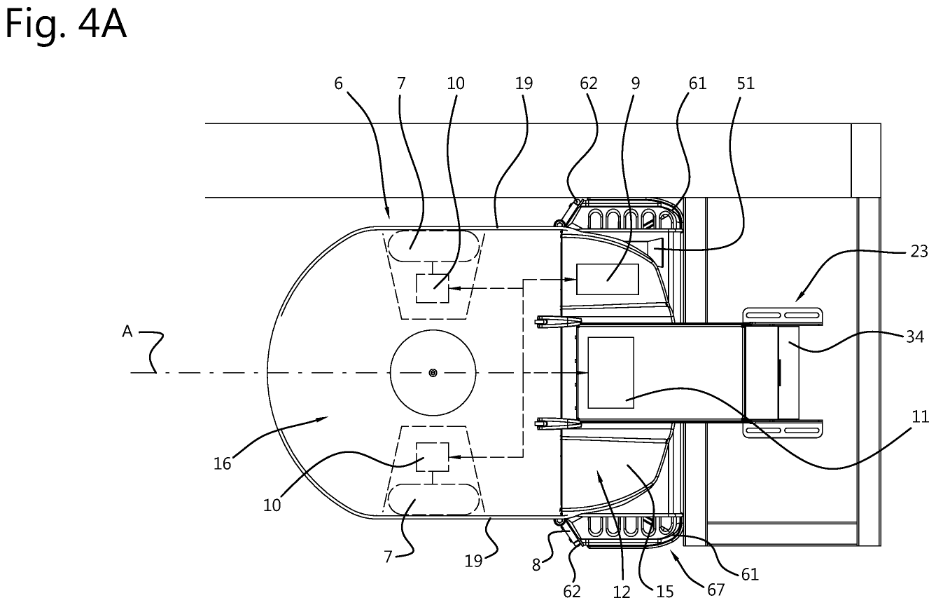

FIG. 4A shows a top view of the manure removing vehicle in the charging station illustrated in FIG. 3.

FIG. 4B shows a top view in cross section of the manure removing vehicle illustrated in FIG. 4A.

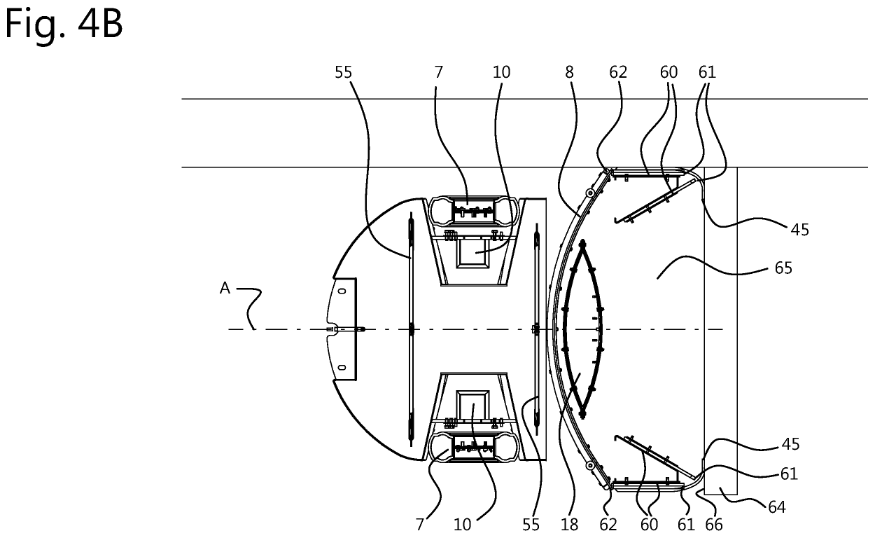

FIG. 5 shows an enlarged view in perspective of the receiving body of the manure removing vehicle of the system according to FIGS. 1-4.

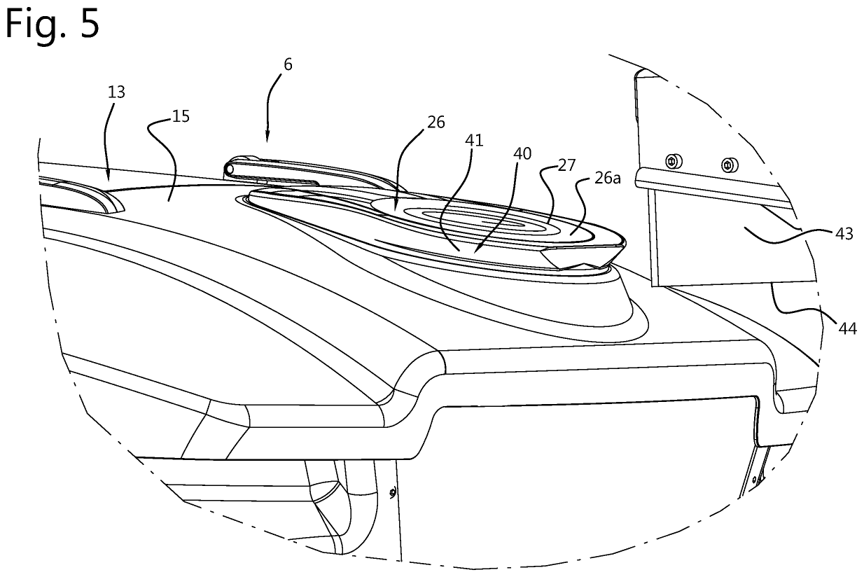

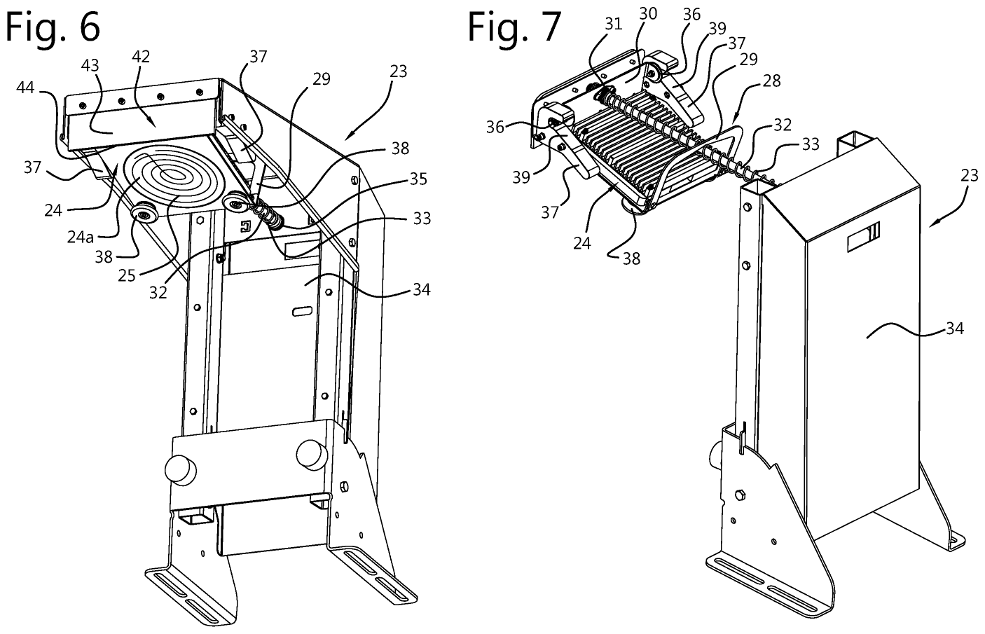

FIGS. 6 and 7 show views in perspective of the charging station of the system according to FIGS. 1-4, wherein FIG. 7 is partially cut-away.

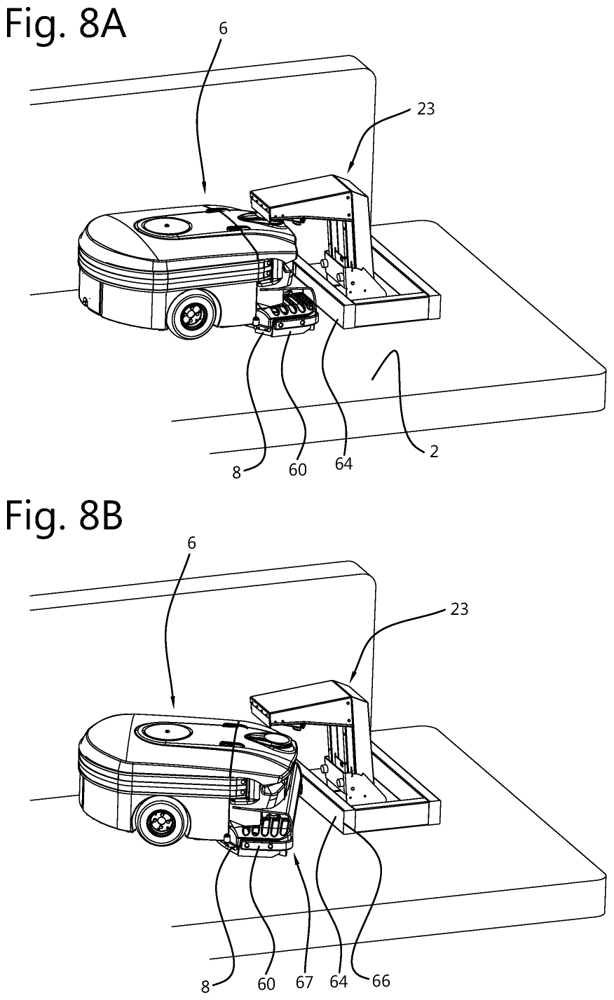

FIGS. 8A-8C show views in perspective of different steps when the manure removing vehicle leaves the charging station of the system illustrated in FIGS. 1-4.

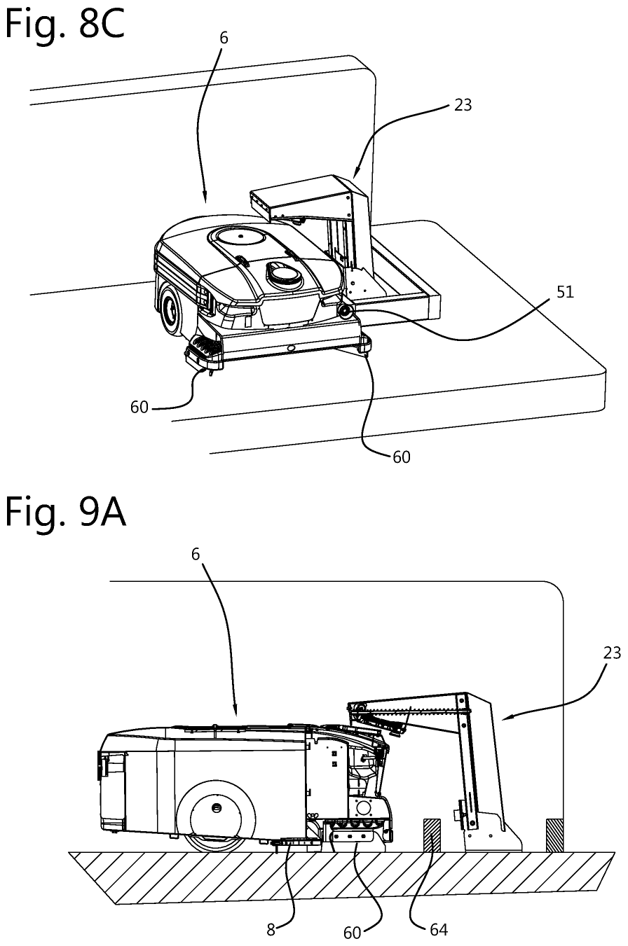

FIGS. 9A and 9B show partially cut-away side views of the steps illustrated in FIGS. 8A and 8B.

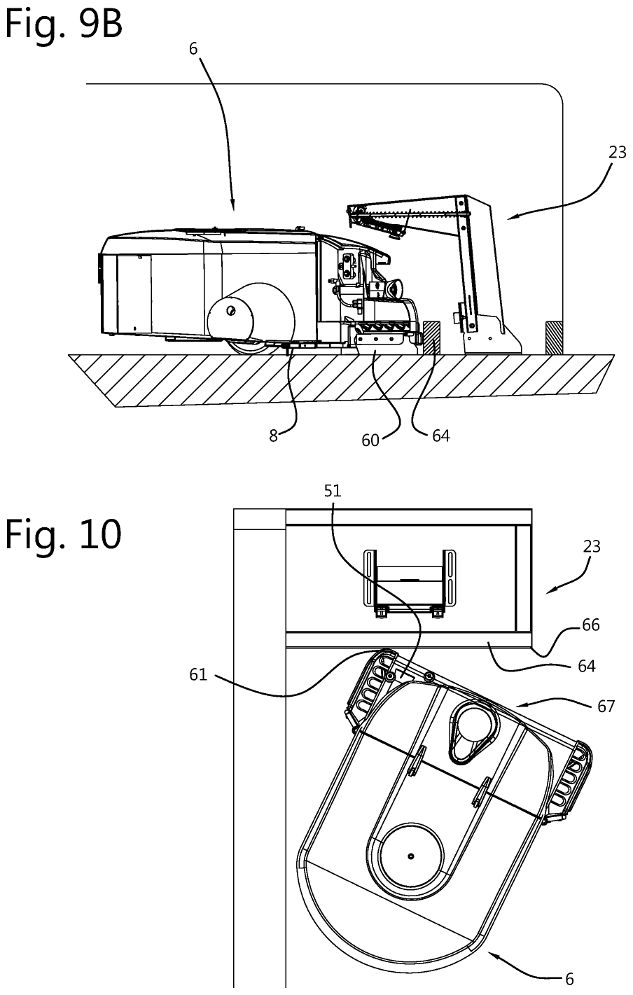

FIG. 10 shows a top view of the step illustrated in FIGS. 8B and 9B.

FIG. 1 shows a system 1 for removing manure and/or urine from a solid floor 2 in a barn 3 which is configured as a typical free-range barn for cows with cubicles 5. On the floor 2 are manure and urine of the animals 4, and for example also straw, sand and/or sawdust, with which the cubicles 5 are filled. In this exemplary embodiment, the system 1 comprises an autonomous manure removing vehicle 6 for removing manure. The manure removing vehicle 6 is situated on the floor 2 between the animals 4. The manure removing vehicle 6 rests on the floor 2 by means of two wheels 7, a manure slider 8 and sliding supports 60 (see FIGS. 2, 4A and 4B). In this exemplary embodiment, the manure removing vehicle 6 comprises four sliding supports 60, namely a straight sliding support 60 and a curved sliding support 60 on each side, i.e. on the left and on the right, of the manure removing vehicle 6. However, the manure removing vehicle 6 may also rest on the floor in a different way, for example only by means of the two wheels 7 and the manure slider 8. The manure removing vehicle 6 may also comprise a front wheel (not shown).

The manure slider 8 is configured for moving and/or scraping manure across the floor 2. While the manure removing vehicle 6 is travelling across the floor 2, the manure slider 8 is in contact with the floor 2 in order to move and/or scrape any manure present thereon. The manure slider 8 has, for example, a flexible bottom edge 59 which scrapes across the floor 2. With the solid barn floor 2, an amount of manure then accumulates in front of the manure slider 8, i.e. a “manure bath” is created in front of the manure slider 8. In this exemplary embodiment, the manure slider 8 forms part of a manure feed device for introducing manure from the floor 2 and moving the introduced manure to a manure storage container 16 (see FIG. 3), which defines an interior, in which manure can temporarily be collected.

The sliding supports 60 are arranged in front of the manure slider 8 on either side thereof. The sliding supports 60 rest on the floor 2 while the manure removing vehicle 6 travels across the floor 2. The sliding supports 60 are in contact with the floor 2 in a substantially manure blocking manner. In this exemplary embodiment, the straight sliding supports 60 adjoin the front ends 62 of the manure slider 8 in a substantially manure blocking manner. The manure slider 8 and the sliding supports 60 form a manure bounding device for bounding manure on the floor while the manure removing vehicle 6 travels across the floor 2. The bottom edge 59 of the manure slider 8 and the bottom edge 63 of the sliding supports 60 on either side of the manure slider 8 together form a composite manure bounding edge. On the rear side and laterally, the manure on the floor 2 in front of the manure slider 8 is delimited by said manure bounding edge, i.e. manure is substantially contained and cannot flow under the bottom edges of the manure slider 8 or sliding supports 60.

The manure removing vehicle 6 is unmanned and self-propelled. The manure removing vehicle 6 is able to find its way autonomously by means of an electronic control system 9 (see FIG. 4A) comprising sensors, such as an ultrasound sensor and a gyroscope. On the basis of the signals detected by the sensors, the control system 9 controls a drive system comprising electrical drive motors 10 for the wheels 7 of the manure removing vehicle 6. Due to the fact that the wheels 7 are controllable independently from one another, the manure removing vehicle 6 can be controlled and travel along a desired route in the barn 3.

The drive system and the control system 9 are powered by a battery system 11 for storing electrical energy on board the manure removing vehicle 6. The battery system 11 comprises one or more rechargeable batteries, in particular 24V lithium batteries. The battery system 11 and electronic components of the control system 9 which are not able to cope with manure or urine are incorporated in a housing 12 of the manure removing vehicle 6. The housing 12 forms an electrical enclosure for accommodating electrical and/or electronic components of the manure removing vehicle 6.

In this exemplary embodiment, this housing 12 is arranged substantially above and in front of the manure slider 8. On the top side, the housing 12 comprises an access opening 14, for example for maintenance work. The access opening 14 is closable by means of a hingeable cover 15. The cover 15 is movable between a closed position, in which the access opening 14 is closed by the cover 15, and an open position, in which the interior of the housing 12 is accessible via the access opening 14.

The manure storage container 16 is situated behind the housing 12. The manure storage container 16 comprises a bottom 17 which runs obliquely downwards to a manure feed and discharge opening 18, which is situated on the lowest level of the bottom 17. The interior of the manure storage container 16 is furthermore delimited by the inner side of the two side walls 19 of the manure removing vehicle 6. In every side wall 19, a wheel house for accommodating a wheel 7 and associated electrical drive motor 10 is formed (see FIGS. 4A and 4B).

Although in this exemplary embodiment, the manure storage container 16 has a single manure feed and discharge opening 18, i.e. manure picked up from the floor 2 is fed to the manure storage container 16 via said opening 18 and the collected manure leaves the manure storage container 16 via the same opening 18 when the manure storage container 16 is emptied, it is also possible for the manure removing vehicle 6 to have two separate openings: a first opening for supplying manure and a second opening for discharging manure.

During travelling, manure on the floor 2 is gathered in front of the manure slider 8 which extends partially around the manure feed and discharge opening 18. A “manure bath” is formed in front of the manure slider 8. In this exemplary embodiment, the manure feed device comprises a vacuum pump in order to create a partial vacuum in the interior of the manure storage container 16, as a result of which manure from the manure bath is sucked up from the floor 2 and flows to the interior of the manure storage container 16 via the manure feed and discharge opening 18. There, the manure is stored until the manure storage container 16 is substantially full.

A manure feed device for sucking up manure is described in detail in WO 2013/010785 A1, the contents of which are deemed to have been incorporated in the present description by reference and will not be explained in greater detail now. It should be noted that the manure feed device may also be configured differently. Instead of sucking up the manure, as described above, the manure feed device may, for example, comprise a mechanical picking-up mechanism for picking up or scooping up manure from the floor 2. Subsequently, the manure is, for example, moved upwards by means of a rotor and then ends up in the interior of the manure storage container via a manure feed opening.

When the manure storage container 16 is full, the manure feed device stops introducing manure and the manure removing vehicle 6 travels to a dump 20 in order to empty the manure storage container 16. Although the dump may be situated outside the barn, in particular with an open-air manure reservoir, such as a so-called “manure lagoon”, according to this exemplary embodiment, the dump 20 is arranged in the barn 3. At the dump 20, a dumping opening 21 is provided in the floor 2 which leads out into a manure reservoir 22 which extends under the floor 2. When the manure removing vehicle 6 is positioned with the manure feed and discharge opening 18 over the dumping opening 21, the control system 9 switches off the vacuum pump and an air-supply valve opens, as a result of which the partial vacuum in the interior of the manure storage container 16 is canceled and the manure flows out of the manure storage container 16, through the dumping opening 21 and into the manure reservoir 22 on account of the force of gravity. However, emptying the manure may also be configured differently. In a manure removing vehicle which picks up manure and moves it upwards via a rotor to the manure storage container, for example. a separate manure discharge opening is provided which is closable via a controllable discharge valve. At the dump, the discharge valve swings away, for example, in order to open the manure discharge opening, so that the manure from the manure storage container drops into the manure reservoir.

Although the above-described manure removing vehicle 6 is configured for accommodating the manure and moving the accommodated manure to a dump 20, the autonomous manure removing vehicle may however also be configured to move and/or scrape manure through slot-shaped openings of a “grid floor” or “slatted floor” in the barn (not illustrated). In other words, in this case, the manure slider scrapes across a grid floor of the barn while the manure removing vehicle is travelling in order to force the manure through the slots which then drops into the manure reservoir under the floor on account of the force of gravity. In particular, in the case of such a manure removing vehicle, the sliding supports 60 may be omitted, so that the vehicle rests on the floor of the barn with only two wheels and the manure slider.

The system 1 according to the invention furthermore comprises a charging station 23 for wirelessly charging the battery system 11 of the manure removing vehicle 6. The charging station 23 is situated at a distance from the dump 20. In other words, the charging station 23 is arranged at a first location in the barn 3, and the dump 20 is arranged at a second location in the barn 3, at a travelling distance from the first location, or outside the barn 3 in a “manure lagoon”. The charging station 23 and the dump 20 are arranged so as to be separate from each other. The charging station 23 does not have a dumping opening to pour the manure from the manure storage container 16. The manure is discharged elsewhere, namely at the dump 20. Since the manure reservoir 22 may extend under a large part of the floor 2, it is possible for the manure reservoir 22 to also extend under the charging station 23 (see FIG. 3).

If it is desired to charge the battery system 11, the manure removing vehicle 6 travels to the charging station 23. The charging station 23 determines a charging position for the manure removing vehicle 6 during charging of the battery system 11. In this exemplary embodiment, the system 1 is configured for wirelessly charging the battery system 11 of the manure removing vehicle 6.

As is illustrated in FIGS. 6 and 7, the charging station 23 comprises a transmitting body 24 which is provided with a transmitting plate 24a comprising a primary coil 25 (diagrammatically illustrated in FIG. 6). The transmitting plate 24a is arranged adjacent to a downwardly facing flat surface of the transmitting body 24. Viewed in a direction opposite to the forward direction of travel y when the manure removing vehicle 6 enters the charging station 23, the flat surface of the transmitting body 24 of the charging station 23 runs obliquely upwards with respect to the horizontal.

The manure removing vehicle 6 comprises a receiving body 26 which is provided with a receiving plate 26a comprising a secondary coil 27 (shown diagrammatically in FIG. 5). The receiving plate 26a is arranged adjacent to an upwardly facing flat surface of the receiving body 26. Viewed in the forward direction of travel y towards the charging station 23, the flat surface of the receiving body 26 of the manure removing vehicle 6 runs obliquely downwards with respect to the horizontal.

The transmitting plate 24a and the receiving plate 26a are each formed by a charging pad, in this exemplary embodiment having a diameter of approximately 16 cm and a thickness of approximately 2 cm. The “charging pads” 24a, 26a are housed in the transmitting body 24 and the receiving body 26, respectively. The “charging pads” 24a, 26a comprise the primary coil 25 and the secondary coil 27, respectively. The primary and secondary coil 25, 27 may each comprise one or more induction coils, for example a packet of induction coils.

The receiving body 26 is fixedly secured to a top side 13 of the manure removing vehicle 6. The top side 13 of the manure removing vehicle 6 is defined by a substantially flattened top surface. The receiving body 26 lies next to said top surface. In this location, the receiving body 26 is less susceptible to soiling and corrosion, and the risk of damage due to kicks from cows is also minimal.

In this exemplary embodiment, the flattened top surface has a slightly rounded or spherical shape, but the top surface may also define a substantially horizontal face (not shown). The top surface forms a part of an outer wall, i.e. the outer contour of the manure removing vehicle 6. The top surface determines the height of the manure removing vehicle 6, which is approximately 60 cm in this exemplary embodiment.

As is illustrated in FIG. 5, the receiving body 26 in this exemplary embodiment is arranged on the cover 15 which defines a part of the flattened top surface. Viewed in a vertical direction, the receiving body 26 is situated directly above the interior of the housing 12. As a result thereof, a short connection to the control system 9 and the battery system 11 is possible, while this connection additionally only runs in an area which is sealed against soiling by manure, urine and the like.

The receiving body 26 is furthermore arranged in a vertical central longitudinal plane A of the manure removing vehicle 6 (see FIGS. 4A and 4B). The vertical central longitudinal plane A is situated in the center between the side walls 19 of the manure removing vehicle 6. In other words, the receiving body 26 is arranged on the top side of the manure removing vehicle 6 in the center between the side walls 19. Viewed in a direction at right angles to the forward direction of travel y of the manure removing vehicle 6, the receiving body 26 is situated in the center of the manure removing vehicle 6.

When animals 4 relieve themselves on the top side 13 of the manure removing vehicle 6, it is possible that manure remains behind. In practice, this manure collects mainly in elongate strips on the top side 13 adjacent to the side walls 19. In the center, the top side 13 of the manure removing vehicle 6 is less prone to being soiled by manure. Therefore, the receiving body 26 in the center of the manure removing vehicle 6 suffers relatively little from soiling and corrosion from manure.

In order to wirelessly charge the battery system 11, the primary coil 25 of the transmitting body 24 and the secondary coil 27 of the receiving body 26 are mutually aligned in a charging position, in which electrical energy is wirelessly transmittable from the primary coil 25 to the secondary coil 27. The height of the downwardly facing flat surface of the transmitting body 24 is adjusted in such a way to the height of the upwardly facing flat surface of the receiving body 26 of the manure removing vehicle 6, that these flat surfaces are arrangeable over and/or on top of one another in the charging position.

In the charging position, the transmitting plate 24a and the receiving plate 26a are above one another. For a reliable and effective wireless energy transmission, it is desirable to position the primary coil 25 of the transmitting body 24 close to the secondary coil 27 of the receiving body 26, in particular at a mutual distance of, for example, at most 1 or 2 cm.

In order to reliably align the flat surfaces of the transmitting body 24 and the receiving body 26 on top of one another, the receiving body 26 is first cleaned in order to largely remove any manure and other dirt present thereon. The reason for this is that the receiving body 26 of the manure removing vehicle 6 becomes (quite heavily) soiled by the manure of the animals 4 during use, often also combined with urine, straw, sand and/or sawdust which are present on the floor 2. After some time, the manure hardens (“becomes stuck”). The manure may furthermore contain chunks or lumps. As a result thereof, the receiving body 26 is usually covered with a layer of manure when the manure removing vehicle 6 enters the charging station 23.

This manure renders it more difficult to arrange the flat surfaces of the transmitting body 24 and the receiving body 26 on top of one another. In order to mutually align the primary coil 25 of the transmitting body 24 and the secondary coil 27 of the receiving body 26 in the charging position, in which electrical energy is wirelessly transmittable from the primary coil 25 to the secondary coil 27 for wirelessly charging the battery system 11, the charging station 23 comprises a cleaning device 42 for removing manure, urine and the like from the receiving body 26 when the manure removing vehicle 6 enters the charging station 23 and before the primary coil 24a of the transmitting body 24 and the secondary coil 26a of the receiving body 26 are mutually aligned in the charging position.

Although the receiving body 26 does not have to be entirely clean, the cleaning device 42 removes the dirt from manure and the like to a sufficient degree from the receiving body 26 to make it possible for the primary coil 25 of the transmitting body 24 and the secondary coil 27 of the receiving body 26 to be mutually aligned in the charging position. After cleaning by the cleaning device 42, there is no more manure or other dirt present to impede alignment in the charging position. In addition, due to the cleaning device 42, the manure removing vehicle 6 brings significantly less manure into the charging station 23, as a result of which the transmitting body 24 of the charging station 23 also becomes soiled less quickly.

The cleaning device 42 comprises a scraping element 43 for scraping manure from the flat surface of the receiving body 26 when the manure removing vehicle 6 enters the charging station 23 in the forward direction of travel y. The scraping element 43 is made from a flexible plastic which, in this exemplary embodiment, comprises polyurethane. On its underside, the scraping element 43 comprises a scraping edge 44 which comes into contact with the flat surface of the receiving body 26 when the manure removing vehicle 6 enters the charging station 23 while passing under the scraping element 43. The scraping edge 44 forms a substantially horizontal, straight bottom edge which extends substantially at right angles to the direction of travel y of the manure removing vehicle 6.

When the scraping edge 44 moves across the flat surface of the receiving body 26 in order to remove manure, the scraping edge 44 is elastically deformed. During contact with the flat surface of the receiving body 26, the scraping edge 44 is bent, so that the scraping edge 44 exerts a pressure force on the receiving body 26 during scraping. Manure is removed while the bent scraping edge 44 of the scraping element 43 moves across the flat surface of the receiving body 26. When the manure removing vehicle 6 has left the charging station 23 and the scraping edge 44 no longer makes contact, the scraping element 43 returns to its original shape, as shown in FIG. 6.

Optionally, the cleaning device 42 comprises a water device for applying water to the receiving body 26 and which is, for example, configured as a water sprayer (not shown). The water sprayer sprays water on the flat surface of the receiving body 26 before the scraping element 43 scrapes across said flat surface in order to remove manure. By adding water to manure which is present as dirt on the flat surface of the receiving body 26, the scraping element 43 is able to remove said manure in a simpler and more efficient way.

Only after the flat surface of the receiving body 26 has been cleaned and the manure removing vehicle 6 has subsequently travelled further into the charging station, does the receiving body 26 of the manure removing vehicle 6 engage with the transmitting body 24 of the charging station 23 which is in a waiting position or starting position. The receiving body 26 of the manure removing vehicle 6 then comes into contact with the transmitting body 24 of the charging station 23.

The transmitting body 24 is pretensioned into the waiting position by means of a spring 33. As is shown in FIGS. 6 and 7, the transmitting body 24 is attached to a carriage 28 of the charging station 23, which is movably suspended from a carrying rod 32 at a height above the floor 2. In this exemplary embodiment, the carriage 28 comprises a carrying bracket 29 and a carrier plate 30 with an opening 31. The carrying rod 32 passes through the opening 31, under the carrying bracket 29, with a tolerance and is received in an opening 35 of a carrier frame 34 of the charging station 23 with a tolerance. As a result of this tolerance at the opening 35 of the carrier frame 34, the carrying rod 32 is slightly tiltable with respect to the carrier frame 34.

The carriage 28 comprises in each case a bushing 36 on either side of the carrying rod 32. The bushings 36 are accommodatable in arresting jaws 37 which are attached to the carrier frame 34. The arresting jaws 37 form a pre-stop for the carriage 28 with the transmitting body 24 attached thereto. The pre-stop determines a frontmost position for the transmitting body 24. During alignment, the carriage 28 is movable in a backward direction along a length up to a rearmost position, which is determined by the fact that the manure removing vehicle 6 cannot travel further until an abutting edge 45 on the front side of the manure removing vehicle 6 makes contact with a manure blocking device of the charging station 23 which, in this exemplary embodiment, is formed by a manure blocking beam 64 (see FIGS. 2, 3 and 4). The manure blocking beam 64 is, for example, made from wood or metal.

The spring 33 is pushed onto the carrying rod 32 and is pretensioned between the carrier plate 30 and the carrier frame 34, so that the bushings 36 of the carriage 28 are accommodated in the arresting jaws 37 under a pretensioning force. The transmitting body 24 is then in the waiting position. The transmitting body 24 therefore always returns to the same precisely defined position when the manure removing vehicle 6 has left the charging station 23. As a result thereof, the transmitting body 24 always starts at the same position, which corresponds to the waiting position, during the alignment procedure.

The transmitting body 24 is substantially freely movable from the waiting position, counter to the action of the spring 33. The expression “freely movable” is understood to mean that the transmitting body 24, when moving from the frontmost position, which is determined by the pre-stop formed by the arresting jaws 37, to the rearmost position, which is determined by the manure removing vehicle 6 bearing against the manure blocking beam 64, is movable with respect to the carrier frame 34 of the charging station 23 in order to adjust the position and orientation of the transmitting body 24 to the receiving body 26 of the manure removing vehicle 6 while the manure removing vehicle 6 enters the charging station 23 and the receiving body 26 engages with the transmitting body 24.

In this case, the transmitting body 24 may perform a translational movement in the direction of travel y, so that the bushings 36 are released from the arresting jaws 37. The transmitting body 24 may also perform a translational movement in a direction at right angles to the direction of travel y, i.e. to the left and to the right. In addition, the transmitting body 24 may swing to the left and to the right about a substantially vertical swing axis by sliding the carrying bracket 29 over the carrying rod 32, and by slightly turning counterclockwise and clockwise about the carrying rod 32.

The transmitting body 24 furthermore comprises two centering bosses 38, which are arranged on either side of the carrying rod 32. The centering bosses 38 are situated in corner regions to the left and to the right of the transmitting body 24, so that the flat surface which borders the transmitting plate 24a remains clear, i.e. that the flat surface of the receiving body 26 can be arranged thereon. The centering bosses 38 have an undercut shape. The undercut shape prevents the transmitting body 24 from passing over the receiving body 26 while the manure removing vehicle 6 enters the charging station 23 in the forward direction of travel y.

As is illustrated in FIG. 5, a front side of the receiving body 26 comprises a centering edge 40 which protrudes upwards substantially at right angles from the cover 15 of the manure removing vehicle 6. The centering edge 40 forms an upright collar which partially surrounds the receiving plate 26a. Viewed in a direction opposite to the forward direction of travel y, i.e. from the front side of the manure removing vehicle 6 towards the back, the centering edge 40 on either side of the center axis of the receiving plate 26a runs off in an outward direction. In this exemplary embodiment, the centering edge 40 on the front side of the receiving body 26 approximately has the shape of a semi-circle. As a result thereof, the centering edge 40 is self-aligning. The centering edge 40 furthermore comprises a groove 41 which is configured to cooperate with the undercut centering bosses 38 of the transmitting body 24.

The height of the groove 41 of the centering edge 40 of the receiving body 26 and the height of the centering bosses 38 of the transmitting body 24 are adapted to one another, i.e. when the manure removing vehicle 6 enters the charging station 23, the centering edge 40 first makes contact with at least one of the centering bosses 38 of the transmitting body 36 in the waiting position. The undercut shape of this centering boss 38 is in this case received in the groove 41, so that the transmitting body 24 does not pass over the receiving body 26 and returns to the waiting position. As the manure removing vehicle 6 continues to travel, the other centering boss 38 also engages in the groove 41. In other words, the groove 41 of the centering edge 40 is caught by the centering bosses 38 of the transmitting body 24. The centering bosses 38 then engage in the groove 41 of the centering edge 40 on either side of the center axis of the receiving plate 26a. Due to the fact that the centering edge 40 is in the shape of a semi-circle, the transmitting body 24 is self-aligning, i.e. the transmitting body 24 laterally, i.e. at right angles to the direction of travel y, performs a translational movement in order to achieve accurate alignment.

By means of the centering bosses 38, the transmitting body 24 pushes the centering edge 40 out of the waiting position, counter to the pretensioning action. In this case, the bushings 36 move out of the arresting jaws 37 and downward over paths 39, while the carrying rod 32 tilts slightly downwards with respect to the opening 35 in the carrier frame 34. As a result thereof, the flat surface of the transmitting body 24 also tilts against the flat surface of the receiving body 26, so that the transmitting plate 24a and the receiving plate 26a come to lie substantially parallel to each other. Thus, the manure removing vehicle 6 is maneuvered under the transmitting body 24 of the charging station 23 in such a way that the primary coil 25 of the transmitting body 24 is aligned over the secondary coil 27 of the receiving body 26 in the charging position.

Since the transmitting body 24 was moved counter to the pretensioning action, the flat surfaces of the transmitting body 24 and the receiving body 26 are pushed against each other in the charging position. Also, due to the own weight of the carriage 28 comprising the transmitting body 24, the flat surface of the transmitting body 24 “falls” securely against the flat surface of the receiving body 26.

If the manure removing vehicle 6 continues to travel after it has reached the charging position, the flat surfaces of the transmitting body 24 and the receiving body 26 remain on top of one another, while the carriage 28 with the transmitting body 24 continues to slide over the carrying rod 32 in the direction of travel y. In this case, the bushings 36 are released from the tracks 39. As has been mentioned above, the manure removing vehicle 6 can continue to travel until the front of the abutting edge 45 comes into contact with the manure blocking beam 64 of the charging station 23 (see FIGS. 2, 3 and 4). In this case, front ends 61 of the sliding supports 60 come to lie near or against the manure blocking beam 64.

The manure removing vehicle 6 furthermore comprises a water system 50 which is configured to spray water on the floor 2 (diagrammatically shown in FIG. 3). It is advantageous to wet the floor 2 in order to support removal of manure from the floor 2. The water system 50 is optional. In this exemplary embodiment, the water system 50 comprises a water feed connection 51 (see FIG. 4A) for supplying water to the water system 50. The water feed connection 51 is couplable to a water supply connection which is situated, for example, at a water station at another location in the barn 3 (not illustrated). The water supply connection may be connected to a water main or a water buffer tank (not shown).

By means of a conduit system 54, the water feed connection 51 of the manure removing vehicle 6 is connected to two water reservoirs 55 for holding water. In this exemplary embodiment, the water reservoirs 55 are formed as flexible water bags, as described in WO 2017/069615 A1. In FIGS. 3 and 4B, the water bags 55 are not filled with water and therefore substantially flat. When the water bags 55 are filled with water, the volume of the water bags 55 increases. Obviously, only one water reservoir can be used, and the water reservoir may be configured differently, for example as a plastic or metal tank (not shown).

By means of the conduit system 54, the water reservoirs 55 are furthermore connected to one or more spray heads for spraying water onto the floor 2 (not illustrated). For example, a spray head of the water system 50 is fitted to a front side of the manure removing vehicle 6, wherein said spray head sprays water onto the floor 2 in front of the manure removing vehicle 6 while the manure removing vehicle 6 is travelling forwards. In other words, this spray head always sprays water in an area of the floor 2 towards which the manure removing vehicle 6 is moving. The spray head may also be used to spray water onto the floor in the charging station 23. In addition, the water system 50 may comprise a further spray head which is, for example, configured to spray the area of the floor 2 behind the manure removing vehicle 6 with water.

When the manure removing vehicle 6 enters the charging station 23 and maneuvers itself into the charging position, so that electrical energy is transmittable in order to charge the battery system 11, the manure blocking beam 64 of the charging station 23 is situated near or against the front ends 61 of the sliding supports 60 in such a way that the manure blocking beam 64, the sliding supports 60 and the manure slider 8 together form a holding space 65 which is substantially closed off for manure (see FIG. 4B). The holding space 65 determines a floor surface in the charging station 23 which is substantially closed off for manure, i.e. manure which the manure slider 8 sweeps into the charging station 23 is contained on a portion of the solid floor 2 in the charging station 23.

The holding space 65 is thus formed by a continuous composite manure blocking edge which comprises the bottom edge 59 of the manure slider 8, the bottom edge 63 of the straight sliding supports 60 on either side of the manure slider 8, the bottom edge of the front ends 61 of the curved sliding supports 61, and the bottom edge of the manure blocking beam 64. Although slits may be present through which a small flow of manure could possibly seep away, in particular thin manure, said bottom edges substantially adjoin each other in a manure blocking manner. In other words, while the manure removing vehicle 6 in the charging position is stationary on the floor 2 in the charging station 23 in order to charge the battery system 11, the manure blocking beam 64 of the charging station 23 prevents the manure present in front of the manure slider 8 from running off across the floor 2. The manure which is situated in front of the manure slider 8 and between the sliding supports 60 is enclosed by means of the manure blocking beam 64, i.e. said manure remains within the holding space 65 which is substantially closed off for manure. As a result thereof, the floor 2 in and around the charging station 23 remains clean for longer, so that the charging of the battery system 11 is less quickly adversely affected by soiling caused by manure flowing off.

After the control system 9 has determined that the battery system 11 has been charged sufficiently, the manure removing vehicle 6 leaves the charging station 23. In this exemplary embodiment, the manure removing vehicle 6 first reverses slightly in order to uncouple the receiving body 26 from the transmitting body 24 of the charging station 23 and interrupt the charging operation, and subsequently rotates to leave the charging station 23 in a lateral direction. This is due to the fact that the manure removing vehicle 6 cannot leave the charging station 23 in a forward, straight direction after the charging operation, because the charging station 23 is arranged in front of the manure removing vehicle 6 and therefore forms an obstruction. In this exemplary embodiment, the manure removing vehicle 6 first reverses over a small distance, as is illustrated in FIGS. 8A and 9A, and then the manure removing vehicle 6 rotates to leave the charging station 23 (see FIGS. 8B, 9B and 10). Eventually, the manure removing vehicle 6 leaves the charging station 23 in a transverse direction, as is shown in FIG. 8C. The side of the charging station 23 where the manure removing vehicle 6 leaves the charging station 23 in a lateral direction, forms an exit side 67. In this case, the right-hand side of the charging station 23 forms the exit side 67.

The control system 9 is configured to control the drive system of the manure removing vehicle 6 in such a way that, while rotating to leave the charging station 23, the front ends 61 which, in the charging position of the manure removing vehicle 6, lie near or against the manure blocking beam 64 on the side situated opposite the exit side 67, i.e. in this exemplary embodiment the front ends 61 of the straight and curved sliding supports 60 on the left-hand side, move closely along at least a part of the manure blocking beam 64 (see FIGS. 8B, 9B and 10) or even slide or scrape along the latter (not shown) up to an outer end 66 of the manure blocking beam 64. During charging, the manure will have spread across the floor surface of the holding space 65. When the manure removing vehicle 6 leaves the charging station 23, this manure is freely spread out on the floor 2 in the charging station 23. By causing the manure removing vehicle 6 to immediately make a sharp bend after reversing to uncouple the receiving body 26 in order to leave the charging station 23, wherein the front ends 61 of the left sliding supports 60, i.e. the straight and curved sliding support 60 on the left-hand side, move closely along and substantially parallel to the manure blocking beam 64 up to the outer end 66 thereof or, in this case, even make contact with the manure blocking beam 64 (not shown), the manure removing vehicle 6 sweeps virtually the entire released manure. The manure which was present on the floor 2 in the holding space 65 during charging is largely removed by the manure removing vehicle 6 and is introduced into the manure storage container 16, so that hardly any manure remains behind. Only in the furthest left-hand corner does a minimal amount of manure remain behind which the farmer can remove manually. As a result thereof, the charging station 23 remains clean for a particularly long time.

When the manure removing vehicle 6 has left the charging station 23, the transmitting body 24 has returned to the waiting position, due to the pretensioning action of the spring 33. In said waiting position, the transmitting body 24 is then again in the same precisely defined position. Every time the battery system 11 of the manure removing vehicle 6 (or of a second or further manure removing vehicle) has to be charged, alignment can be performed in a reliable manner.

The invention is not limited to the exemplary embodiment illustrated in the figures. The person skilled in the art may come up with various modifications which are within the scope of the invention. In particular, the manure feed device of the manure removing vehicle may be configured differently. Instead of sucking up manure as described above, the manure feed device may comprise a mechanical scooping-up mechanism for scooping up manure from the floor. It is also possible for the manure removing vehicle to comprise two separate openings for supplying and discharging, respectively, manure, i.e. a manure feed opening and a manure discharge opening. The manure is then moved upwards, for example by means of a rotating input feature, and ends up in the interior of the manure storage container via the manure feed opening. The manure may be discharged via the manure discharge opening. With such a manure removing vehicle, it is optionally also possible to use a water system for wetting the floor as described above.

1. A system for removing manure from a floor in a barn for animals, the system comprising:
an autonomous manure removing vehicle, comprising:
a drive system for driving the manure removing vehicle, the drive system being provided with at least one electrical drive motor;
an electronic control system connected to the drive system for control thereof;
a battery system for storing electrical energy, the battery system being connected to the drive system and the control system; and
a manure bounding device comprising a manure slider, wherein the manure slider is configured to move manure over the floor while the manure removing vehicle travels across the floor, and wherein the manure bounding device is configured to at least partially bound the manure present on the floor in front of the manure slider; and
a charging station for charging the battery system of the manure removing vehicle when the manure removing vehicle is in the charging station in a charging position,
wherein the charging station comprises a manure blocking device configured to define, together with the manure bounding device, in the charging position of the manure removing vehicle, a holding space substantially closed off for manure.

2. The system as claimed in claim 1, wherein the manure slider is configured to collect an amount of manure in front of the manure slider while the manure removing vehicle travels across the floor, and
wherein the manure removing vehicle is provided with a manure storage container, and a manure feed device for introducing manure collected in front of the manure slider while the manure removing vehicle is travelling and for moving said introduced manure to the manure storage container.

3. The system as claimed in claim 2, wherein the manure removing vehicle comprises a manure discharge opening for discharging manure from the manure storage container.

4. The system as claimed in claim 2, wherein the system comprises at least one dump situated at a distance from the charging station.

5. The system as claimed in claim 4, wherein the dump is provided with a dumping opening in the floor for dumping manure from the manure discharge opening of the manure storage container through the dumping opening into a manure reservoir extending under the floor.

6. The system as claimed in claim 4, wherein the dump is configured for dumping manure from the manure discharge opening of the manure storage container into an open-air manure reservoir.

7. The system as claimed in claim 1, wherein the charging station comprises a substantially solid floor.

8. The system as claimed in claim 9, wherein the manure slider has a slider width, and
wherein the manure blocking device comprises a manure blocking beam having a width substantially corresponding to the slider width of the manure slider.

9. The system as claimed in claim 1, wherein the charging station, in the charging position of the manure removing vehicle, is situated adjacent to a front side of the manure removing vehicle, and
wherein the control system is configured to control the drive system of the manure removing vehicle in such a way that the manure removing vehicle rotates to leave the charging station after the battery system has been charged.

10. The system as claimed in claim 9, wherein the manure bounding device of the manure removing vehicle comprises at least one front end which, in the charging position of the manure removing vehicle, lies near or against the manure blocking device, and
wherein the control system is configured to control the drive system of the manure removing vehicle in such a way that, during the rotation to leave the charging station, said at least one front end moves along and/or in contact with at least a portion of the manure blocking device.

11. The system as claimed in claim 10, wherein the charging station has an exit side via which the manure removing vehicle leaves the charging station in a lateral direction,
wherein the manure blocking device comprises an outer end situated on the exit side of the charging station,
wherein said front end which lies near or against the manure blocking device in the charging position of the manure removing vehicle is situated at a distance from the exit side in said charging position, and
wherein, during the rotation of the manure removing vehicle to leave the charging station, said front end moves along and/or in contact with the manure blocking device up to the outer end.

12. The system as claimed in claim 1, wherein the charging station comprises a transmitting body comprising a primary coil, and the manure removing vehicle comprises a receiving body comprising a secondary coil, and
wherein the manure removing vehicle is maneuverable with respect to the transmitting body of the charging station in such a way that the primary coil of the transmitting body and the secondary coil of the receiving body are mutually aligned in order to wirelessly transfer electrical energy from the primary coil to the secondary coil for wireless charging of the battery system of the manure removing vehicle.

13. The system as claimed in claim 1, wherein the manure slider comprises a flexible bottom edge configured to move and/or scrape manure over the floor.

14. The system as claimed in claim 1, wherein the manure bounding device comprises sliding supports which are arranged in front of the manure slider and on either side thereof,
wherein the sliding supports are configured to rest on the floor while the manure removing vehicle is travelling across the floor, and
wherein the sliding supports each comprise a front end which lies near or against the manure blocking device of the charging station in the charging position of the manure removing vehicle.

15. The system as claimed in claim 1, wherein the system comprises a water system for applying water to the floor of the charging station.

16. In combination, a barn for keeping animals, and the system as claimed in claim 1.

17. A method for removing manure from a floor in a barn for animals, wherein use is made of the system as claimed in claim 1, and
wherein the method comprises:
moving the autonomous manure removing vehicle across the floor of the barn in order to remove manure from the floor;
moving the manure removing vehicle to the charging station; and
maneuvering the manure removing vehicle to the charging position in the charging station, in which the manure blocking device and the manure bounding device together define the holding space is substantially closed off for manure.

18. The system as claimed in claim 1, wherein the charging station, in the charging position of the manure removing vehicle, is situated adjacent to a front side of the manure removing vehicle, and
wherein the control system is configured to control the drive system of the manure removing vehicle in such a way that the manure removing vehicle rotates to leave the charging station after the battery system has been charged, after the manure removing vehicle has first reversed over a distance.

19. The system as claimed in claim 3, wherein the system comprises at least one dump situated at a distance from the charging station.

20. The system as claimed in claim 2, wherein the charging station comprises a substantially solid floor.
